(19) United States
(12) Patent Application Publication
(10) Pub. No.: US 2024/0361219 A1
(43) Pub. Date: Oct. 31, 2024

(54) MULTI-AXIS SHOCK SIMULATION USING BALL DROP TEST

(71) Applicant: Raytheon Company, Waltham, MA (US)

(72) Inventors: Abbas Aghasharif, Tuscon, AZ (US); Roger C. Esplin, Marana, AZ (US); Peter H. Vo, Oro Valley, AZ (US)

(73) Assignee: Raytheon Company, Waltham, MA (US)

(21) Appl. No.: 18/140,824

(22) Filed: Apr. 28, 2023

(51) Int. Cl. G01N 3/303; G01N 3/06

(52) U.S. Cl. CPC G01N 3/303; G01N 3/062; G01N 2203/0256; G01N 2203/0676

(57) ABSTRACT

A shock testing apparatus includes a tower extending upward from a base. The tower includes a guide extending down the tower. A strike plate assembly includes a strike plate positioned below the guide for receiving mechanical shock from a striker striking out from the guide. A tri-axial accelerometer is mounted to the strike plate for data acquisition of three-dimensional shock wave acceleration data. A method of mechanical shock testing components includes dropping a striker onto a strike plate on which is mounted a unit under test (UUT) to generate three-dimensional shock waves through the strike plate. The method includes acquiring data indicative of acceleration in three orthogonal directions in at least one of the strike plate or UUT for a single drop of the striker.

### STATEMENT REGARDING FEDERALLY SPONSORED RESEARCH OR DEVELOPMENT

This invention was made with government support under Contract No. FA8672-17-D-0004 awarded by the U.S. Air Force. The U.S. government has certain rights in the invention.

### BACKGROUND

### 1. Field

The present disclosure relates to testing for shock, and more particularly to testing components such as electronic components for their ability to survive mechanical shock, including high frequency excitation, to ensure proper specifications are met for field use.

### 2. Description of Related Art

Various electronic components need to operate in high frequency (HF) pyroshock environments at the subsystem or component level, e.g., circuit card assemblies (CCAs), inertial measurement units (IMUs), micro-electro mechanical systems (MEMS) devices, batteries, and the like. In general, the shock requirement is the same for all three orthogonal axes of the test article. The typical test method is to excite the unit under test (UUT) three times, once in each principal direction (orthogonal axis). This approach may lead to over-test by exposing the UUT to excessive shock energy especially along the off-axis (cross-axis) in the high frequency regimes.

The conventional techniques have been considered satisfactory for their intended purpose. However, there is an ever present need for improved systems and methods for shock testing components. This disclosure provides a solution for this need.

### SUMMARY

A shock testing apparatus includes a tower extending upward from a base. The tower includes a guide extending down the tower. A strike plate assembly includes a strike plate positioned below the guide for receiving mechanical shock from a striker striking out from the guide. A tri-axial accelerometer is mounted to the strike plate for data acquisition of three-dimensional shock wave acceleration data.

The guide can include a tube supported vertically by the tower. The striker can include a steel ball configured to descend through the tube from a top end of the guide, to strike the strike plate. A string can be attached to the steel ball, configured to extend through the tube for retrieval of the steel ball after a test. The tower can include a ruled standard extending parallel to the tube. The string can include a ruler mark. The ruler mark can be positioned on the string to delimit height versus a mark on the ruled standard for correct starting position for dropping the steel ball through the tube onto the strike plate.

The striker plate assembly can include a support plate operatively connected to the base. A strike plate can be supported from the support plate by a plurality of standoffs. Each of the standoffs in the plurality of standoffs can connect to the strike plate with a mechanical isolator. The strike plate can include a plurality of bores therethrough for mounting a unit under test (UUT) to the strike plate. The UUT can be mounted to the strike plate by fasteners passing through the plurality of bores. The accelerometer can be mounted to the strike plate with fasteners passing through two of the bores in the plurality of bores. The support plate can be adjustably seated on the base and can be configured for adjustment of relative position of the strike plate and the guide.

A method of mechanical shock testing components includes dropping a striker onto a strike plate on which is mounted a unit under test (UUT) to generate three-dimensional shock waves through the strike plate. The method includes acquiring data indicative of acceleration in three orthogonal directions in at least one of the strike plate or UUT for a single drop of the striker.

The method can include analyzing the data to determine if a predetermined minimum shock level and predetermined shock shape were achieved on the UUT for all three orthogonal directions. If the predetermined minimum shock level and predetermined shock shape were not both achieved on the UUT for all three orthogonal directions, the method can include adjusting position of a guide to a new position for the striker relative to the strike plate and repeating dropping the striker and acquiring the data for the new position. If the predetermined minimum shock level and predetermined shock shape were both achieved on the UUT for all three orthogonal directions, the method can further include performing a test on the UUT for functionality of the UUT to determine shock-worthiness of the UUT.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic perspective view of an embodiment of a shock testing apparatus constructed in accordance with the present disclosure, showing the tower and the strike plate assembly;

FIG. 2 is a schematic perspective view of the tower of FIG. 1, showing the guide tube and the ruled standard;

FIG. 3 is a schematic perspective view of the strike plate assembly of FIG. 1, showing the standoffs and isolators connecting the strike plate to the support plate;

FIG. 4 is a schematic perspective view of the strike plate assembly of FIG. 1, showing the unit under test (UUT) mounted to the strike plate;

FIG. 5 is a schematic perspective view of the shock testing apparatus of FIG. 1, showing the striker and a user holding the string of the striker against the ruled standard; and

FIG. 6 is a schematic perspective view of a portion of the shock testing apparatus of FIG. 5, showing the ruled standard and the ruler mark of the string.

### DETAILED DESCRIPTION OF THE PREFERRED EMBODIMENTS

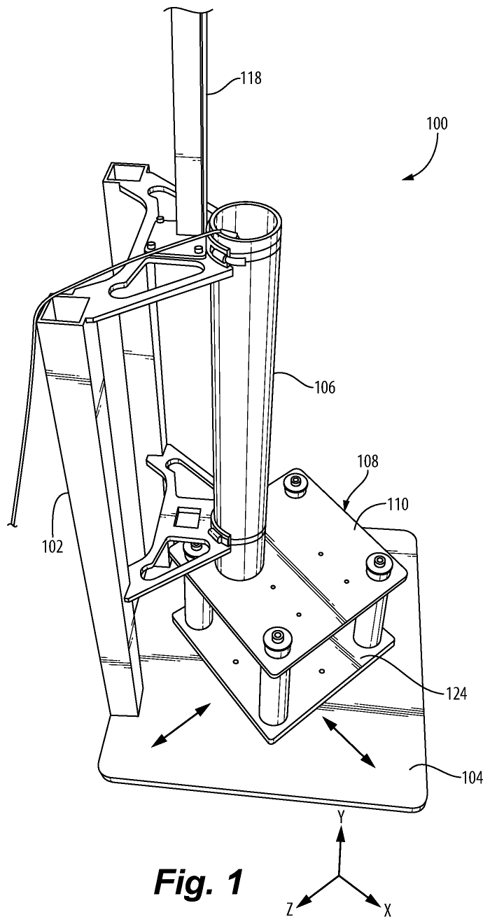

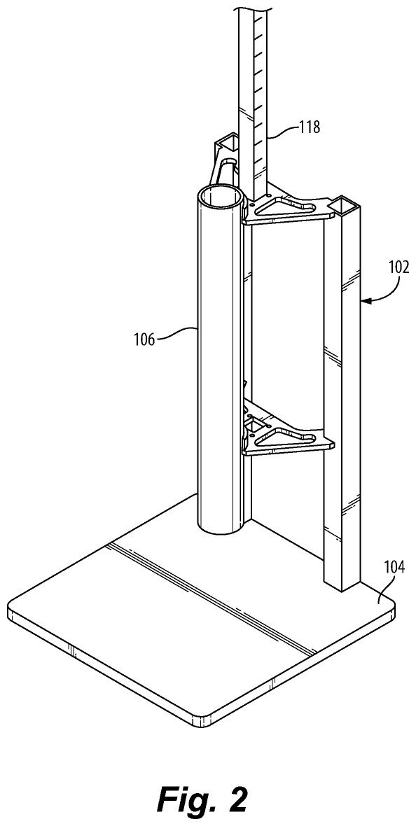

Reference will now be made to the drawings wherein like reference numerals identify similar structural features or aspects of the subject disclosure. For purposes of explanation and illustration, and not limitation, a partial view of an embodiment of a shock testing apparatus in accordance with the disclosure is shown in FIG. 1 and is designated generally by reference character 100. Other embodiments of systems in accordance with the disclosure, or aspects thereof, are provided in FIGS. 2-6, as will be described. The systems and methods described herein can be used to test a unit under test (UUT) simultaneously in three orthogonal axes of high frequency shock acceleration with a single percussive strike.

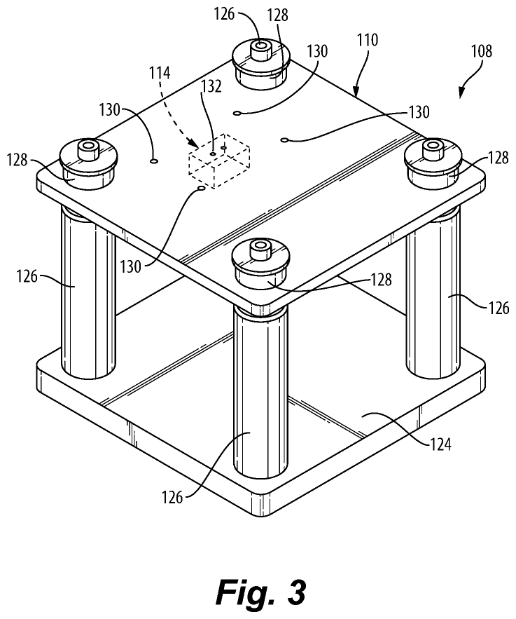

The shock testing apparatus 100 includes a tower 102, e.g. constructed of aluminum or any other suitable material, extending upward from a base 104. The tower 102 includes a guide 106 extending down the tower 102. A strike plate assembly 108, e.g. also generally constructed of aluminum or any other suitable material, includes a strike plate 110 positioned below the guide 106 for receiving mechanical shock from a striker 112 (labeled in FIG. 5) striking out from the guide 106. A tri-axial accelerometer 114 (labeled in FIG. 3) is mounted to the strike plate 110 for data acquisition of three-dimensional shock wave acceleration data.

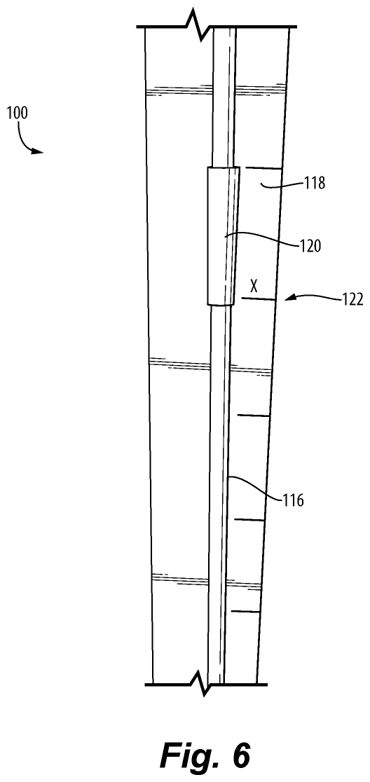

The guide 106 includes a tube supported vertically by the tower 102. The striker 112 (labeled in FIG. 5) includes a steel ball configured to descend, i.e. drop by the force of gravity, through the tube from a top end of the guide 106, to strike the strike plate 110. A string 116 (labeled in FIGS. 5-6) is attached to the steel ball, configured to extend through the tube for retrieval of the steel ball after a drop test. Those skilled in the art will readily appreciate that in lieu of a string, a chain, wire, cable, or any suitable equivalent can be used. The tower 102 includes a ruled standard 118 extending parallel to the tube of the guide 106. The string 116 includes a ruler mark 120 (labeled in FIGS. 5-6). The ruler mark 120 (labeled in FIGS. 5-6) is positioned on the string 116 to delimit height versus a mark 122 (labeled in FIG. 6) on the ruled standard 118 for correct starting position for dropping the steel ball of the striker 112 (labeled FIG. 5) through the tube of the guide 106 onto the strike plate 110. FIG. 2 shows the tower 102 without the strike plate assembly 108.

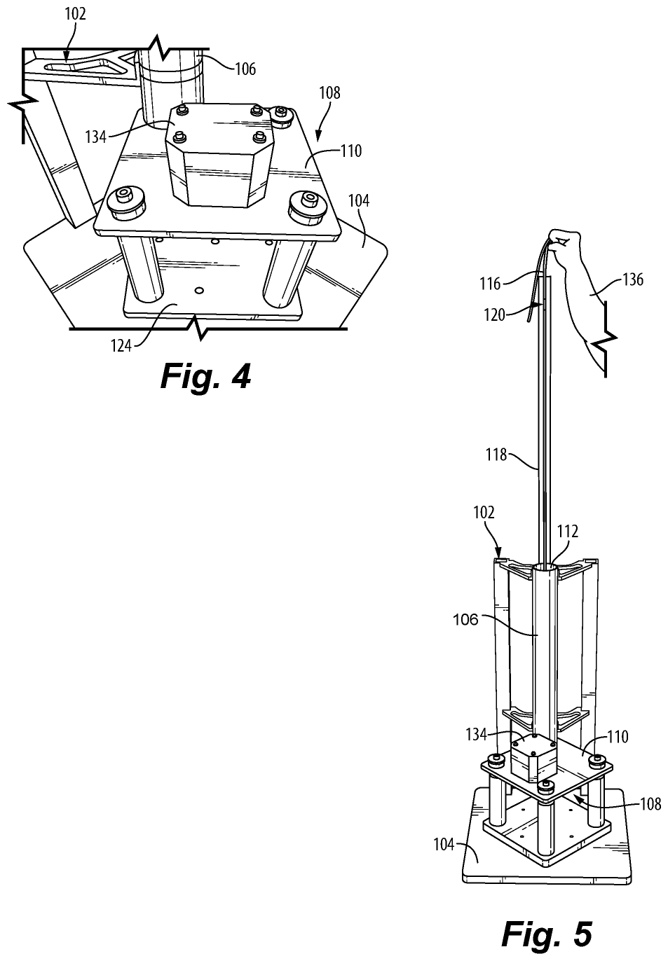

With reference now to FIG. 3, the striker plate assembly 108 includes a support plate 124 operatively connected to the base 104 (labeled in FIGS. 1-2). The strike plate 110 is supported from the support plate 124 by a plurality of standoffs 126, which can be constructed of aluminum or any other suitable material. Each of the standoffs 126 in the plurality of standoffs 126 connects to the strike plate 110 with a mechanical isolator 128, which can be an elastomeric spacer, spring, or other elastic deforming element, which is sandwiched between the strike plate 110 and the respective standoffs 126. The strike plate 110 includes a plurality of bores 130 therethrough for mounting a unit under test (UUT) to the strike plate, and a plurality of bores 132 for mounting the tri-axial accelerometer 114 to the underside of the strike plate 110 as oriented in FIG. 3. As shown in FIGS. 4-5, the UUT 134 is mounted to the strike plate 110 by fasteners passing through the plurality of bores 130. The accelerometer 114 is mounted to the strike plate 110 with fasteners passing through two of the bores 132. The support plate 124 is adjustably, i.e. moveably seated on the base 104, as indicated in FIG. 1 with the double headed arrows. The support plate 124 is configured for adjustment of relative position of the strike plate 110 and the guide 106, and can be fixed into place, e.g. with fasteners passing through the support plate and base 104, after a calibration to find the proper position of the support plate 124 on the base 104 as described below.

With reference now to FIGS. 4-5, a method of mechanical shock testing components includes dropping the striker 112 onto the strike plate 110 on which is mounted a UUT 134 to generate high frequency, e.g. up to 20 kHz or more, three-dimensional shock waves through the strike plate 110. The method includes acquiring data from the accelerometer 114 (labeled in FIG. 3) indicative of acceleration in three orthogonal directions, e.g., the X-, Y-, and Z-directions as labeled in FIG. 1, in at least one of the strike plate 110 or UUT 134 for a single drop of the striker 112. The user 136 raises the string 116 until the ruler mark 120 is at the mark 122 of the ruled standard 118 as shown in FIG. 6. Then the user 136 drops the striker 112 down through the tube of the guide 106 to strike the strike plate 110 with the striker 112 by the force of gravity.

The method includes analyzing the data from the accelerometer 114 (labeled in FIG. 3) to determine if a predetermined minimum shock level and predetermined shock shape were achieved on the UUT 134 for all three orthogonal directions. During set up or initial calibration for a class of UUT 134, if the predetermined minimum shock level and predetermined shock shape were not both achieved on the UUT 134 for all three orthogonal directions labeled in FIG. 1, the method includes adjusting relative position of the guide 106 to a new position for the striker 112 to strike the strike plate 110 and repeating dropping the striker 112 and acquiring the data for the new position. If the predetermined minimum shock level and predetermined shock shape were both achieved on the UUT for all three orthogonal directions, affixing the position of the strike plate assembly 108 on the base 104, so that the test can be repeated for multiple UUT's 134 of the same class, i.e. multiple units of a give UUT model can be tested for mechanical shock after this initial calibration of the position of the strike plate 110 relative to the tube of the guide 106. Once the UUT 134 is attached to the strike plate, the plate is tuned for the desire shock response spectrum. The tuning (calibrating) includes varying the position of the strike plate assembly 108 relative to the tube of the guide 106 where the striker 112 is dropped. The shock response levels, and shape can be manipulated by changing the drop height, the strike angle relative to the UUT 134, and adjusting the impact location relative to the UUT 134 and/or the size of the striker.

After initial calibration, the drop test can be repeated for each individual UUT 134, and for each drop test, the method further includes performing a post-drop test evaluation on the each UUT 134 for functionality of the UUT 134 to determine shock-worthiness of the UUT 134, i.e. after the drop test the UUT 134 can be tested to see if the UUT 134 is functional for its intended purpose, in which case, that UUT 134 passes the shock test.

Systems and methods as disclosed herein provide potential benefits including the following. The multi-axis shock simulation test apparatus eliminates the need to test along each axis separately and reduces the risk of over-test. The test apparatus can be used to simulate the required high frequency shock specification adequately along all three axes—simultaneously. Systems and methods as disclosed herein provide the ability to simulate high frequency shock test on a test article by intentionally amplifying the cross-axis coupling to develop a three-axis component shock test. Also, systems and methods as disclosed herein are safe to use in a laboratory compared to other test methods, e.g, explosive charge. In addition, techniques disclosed herein are highly repeatable and tunable to meet various pyroshock specification requirements.

The methods and systems of the present disclosure, as described above and shown in the drawings, provide for test a unit under test (UUT) simultaneously in three orthogonal axes of high frequency shock acceleration with a single percussive strike. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A shock testing apparatus comprising:
a tower extending upward from a base, the tower including a guide extending down the tower; and
a strike plate assembly including a strike plate positioned below the guide for receiving mechanical shock from a striker striking out from the guide, wherein a tri-axial accelerometer is mounted to the strike plate for data acquisition of three-dimensional shock wave acceleration data.

2. The apparatus as recited in claim 1, wherein the guide includes a tube supported vertically by the tower.

3. The apparatus as recited in claim 2, further comprising the striker, wherein the striker includes a steel ball configured to descend through the tube from a top end of the guide, to strike the strike plate.

4. The apparatus as recited in claim 3, further comprising a string attached to the steel ball, configured to extend through the tube for retrieval of the steel ball after a test.

5. The apparatus as recited in claim 4, wherein the tower includes a ruled standard extending parallel to the tube, wherein the string includes a ruler mark, wherein the ruler mark is positioned on the string to delimit height versus a mark on the ruled standard for correct starting position for dropping the steel ball through the tube onto the strike plate.

6. The apparatus as recited in claim 1, wherein the striker plate assembly includes:
a support plate operatively connected to the base; and
a strike plate supported from the support plate by a plurality of standoffs.

7. The apparatus as recited in claim 6, wherein each of the standoffs in the plurality of standoffs connects to the strike plate with a mechanical isolator.

8. The apparatus as recited in claim 6, wherein the strike plate includes a plurality of bores therethrough for mounting a unit under test (UUT) to the strike plate.

9. The apparatus as recited in claim 8, further comprising the UUT mounted to the strike plate by fasteners passing through the plurality of bores.

10. The apparatus as recited in claim 8, wherein the accelerometer is mounted to the strike plate with fasteners passing through two of the bores in the plurality of bores.

11. The apparatus as recited in claim 6, wherein the support plate is adjustably seated on the base and is configured for adjustment of relative position of the strike plate and the guide.

12. A method of mechanical shock testing components comprising:
dropping a striker onto a strike plate on which is mounted a unit under test (UUT) to generate three-dimensional shock waves through the strike plate; and
acquiring data indicative of acceleration in three orthogonal directions in at least one of the strike plate or UUT for a single drop of the striker.

13. The method as recited in claim 12, further comprising analyzing the data to determine if a predetermined minimum shock level and predetermined shock shape were achieved on the UUT for all three orthogonal directions.

14. The method as recited in claim 13, wherein if the predetermined minimum shock level and predetermined shock shape were not both achieved on the UUT for all three orthogonal directions, the method further comprises:
adjusting position of a guide to a new position for the striker relative to the strike plate and repeating dropping the striker and acquiring the data for the new position.

15. The method as recited in claim 13, wherein if the predetermined minimum shock level and predetermined shock shape were both achieved on the UUT for all three orthogonal directions, the method further comprises:
performing a test on the UUT for functionality of the UUT to determine shock-worthiness of the UUT.
